(19) United States
(12) Patent Application Publication
(10) Pub. No.: US 2007/0261450 A1
(43) Pub. Date: Nov. 15, 2007

(54) DOOR LOCK STRUCTURE

(75) Inventor: Youn Jong Kim, Uiwang-si (KR)

Correspondence Address: FISH & RICHARDSON P.C., P.O. BOX 1022, MINNEAPOLIS, MN, 55440-1022, US

(73) Assignee: NAUTILUS HYOSUNG INC., Seoul (KR)

(21) Appl. No.: 11/746,280

(22) Filed: May 9, 2007

(30) Foreign Application Priority Data
May 9, 2006 (KR) 10-2006-0041540
May 9, 2007 (KR) 10-2006-0041542

(51) Int. Cl. E05B 47/06

(52) U.S. Cl. 70/283

(57) ABSTRACT

A door lock structure including: an object providing a storage space; a door being mounted to the object to be capable of opening and closing the storage space; a locking pin member being provided inside of the door and comprising a fixing pin which reciprocally moves within a door area restricted by an inside surface of the door; and a pinhole member being mounted to the object to selectively combine with the fixing pin within the door area when the door is closed is provided.

### CROSS-REFERENCE TO RELATED APPLICATION

This application claims the benefit of Korean Patent Application Nos. 10-2006-0041540, filed on May 9, 2006, and 10-2006-0041542, filed on May 9, 2006, in the Korean Intellectual Property Office, the disclosures of both of which are incorporated herein by reference.

### BACKGROUND OF THE INVENTION

1. Field of the Invention

The present invention relates to a door lock structure, and more particularly, to a door lock structure which can safely secure an object needing a protection, such as a safe and a financial Automatic Teller Machine (ATM).

2. Description of Related Art

A safe is utilized to secure cash, securities, jewelry, confidential documents, and the like. Specifically, the safe is utilized to protect an object from an unauthorized user's access. However, with developments in safe manufacturing technologies, skills to illegally open the safe are also being improved. Accordingly, there is a need for a safe which is safer and can thwart theft. Particularly, a financial Automatic Teller Machine (ATM) is generally installed in a public location with great amounts of cash, and thus a necessity of safe safety becomes an issue.

A first objective of the safe is to prevent an unauthorized user from opening the safe even though the unauthorized user may utilize any instrument and method. A secondary objective of the safe is to stall for time to allow the police or a private security force to take an appropriate measure by making it difficult to open the safe when the unauthorized user attempts to force open the safe. Currently, various types of cutting tools and welding tools are developed and thus it may be almost impossible to manufacture a safe that an unauthorized user can never open. Accordingly, the most appropriate countermeasure is to manufacture a safe in which it takes time to open the safe when an unauthorized user attempts to force open the safe.

An article, associated with Underwriters Laboratory (UL) certification for safety regulations in the United States, specifies that a corresponding safe should not be opened by a safe specialist for about thirty minutes to be evaluated as a level one of the safety regulation. Specifically, when the entire device, such as an ATM, may not be moved, the device needs to be secured for a maximum possible time.

### BRIEF SUMMARY

An aspect of the present invention provides a door lock structure which can safely secure an object needing a protection, such as a safe and a financial Automatic Teller Machine (ATM).

An aspect of the present invention also provides a door lock structure which can protect a fixing pin from a forceful shock applied to a gap between a door and an object, and can maintain a locked state of a door using the fixing pin.

An aspect of the present invention also provides a door lock structure which can maintain a locked state of a door even when a hinge is destroyed. In this instance, the hinge connects a door and an object to be rotatable with respect to a forceful impact from an outside.

An aspect of the present invention also provides a door lock structure which can maintain a locked state of a door even when a door handle and a shaft of the door handle are damaged.

According to an aspect of the present invention, there is provided a door lock structure including: an object providing a storage space; a door being mounted to the object to be capable of opening and closing the storage space; a locking pin member being provided inside of the door and comprising a fixing pin which reciprocally moves within a door area restricted by an inside surface of the door; and a pinhole member being mounted to the object to selectively combine with the fixing pin within the door area when the door is closed. In this instance, the fixing pin maintains a closed state of the door and may be mounted to the object without being exposed in a gap between the door and the object. Although a forceful shock is applied to the gap between the door and the object from an outside, the fixing pin may be protected and thus the closed state of the door may be maintained.

In an aspect of the present invention, the object may indicate a security apparatus to secure cash, securities, jewelry, confidential documents, and the like, and may generally include a safe, a financial ATM, and the like. Also, the door area may indicate an area restricted by the inside surface of the door and thus may correspond to an area surrounded by boundary areas of the inside surface of the door. Also, the door area may indicate an area defined by the inside surface of the door without being externally protruded from the door.

Also, a door handle may be provided on an external surface of the door to be capable of manipulating a rotation of the door. A rotating bracket and a rotating latch may be mounted inside of the door. In this instance, the rotating bracket is combined with a shaft of the door handle and thereby rotate together with the shaft. The rotating latch receives the rotation of the door handle via the rotating bracket and thereby rotates. The fixing pin may connect with the rotating latch to be interoperable with the rotating latch. Depending upon embodiments, the rotation of the door handle may be directly transmitted to the rotating latch without using the rotating bracket.

The fixing pin of the locking pin member may be constructed to move upwards and downwards and be locked to the object. Depending upon embodiments, the fixing pin may be constructed to reciprocally move along a width direction of the door and thereby be locked by the object.

Also, a link assembly may be applied as a transmission medium to transmit the rotation of the door handle to the fixing pin. The link assembly may be constructed as a multi-fold link portion having various types of shapes and sizes according to a demanded condition. As an example, the link assembly may include a connecting link portion rotatably connecting with the rotating latch; and a rotating link portion connecting with the connecting link portion to be rotatable on the door, and rotatably connecting with the fixing pin. Also, depending upon embodiments, it is possible to transmit the rotation of the rotating latch to the fixing pin by using various types of members, such as a rack, a pinion, and the like, instead of the link assembly.

According to another aspect of the present invention, there is provided a door lock structure including: a door being mounted to an object to be capable of opening and closing a storage space of the object; a door handle being provided on an external surface of the door to be capable of manipulating a rotation; a lock assembly being provided inside of the door to selectively restrain a rotation of the door handle; and a locking pin member comprising at least four fixing pins which are externally protruded from the door to be adjacent to four side corners of the door respectively. According to the above construction, a method of fixing four points may fix a portion corresponding to each of the side corners to the object. Although a hinge rotatably connecting the door and the object is damaged due to a forceful shock from an outside, the door may not be opened due to the fixing pins and thus the locked state of the door may be maintained. Accordingly, an unauthorized user needs to carry out another disassembling operation to disassemble the fixing pins and thus it is possible to delay time to open the safe.

A rotating bracket and a rotating latch may be provided inside of the door. In this instance, the rotating bracket is combined with a shaft of the door handle to rotate together with the shaft. The rotating latch receives the rotation of the door handle via the rotating bracket and thereby rotates. The fixing pin may rotatably connect with the rotating latch. Depending upon embodiments, the rotation of the door handle may be directly transmitted to the rotating latch without using the rotating bracket.

Each fixing pin of the locking pin member may be constructed to be mounted to the object and be protruded from a top surface and a bottom surface of the door along a height direction of the door. Depending upon embodiments, each fixing pin may be mounted to the object and be protruded from both side surfaces of the door along a width direction of the door.

As an example, the locking pin member may include: a first top fixing pin being protruded from a top surface of the door to be adjacent to one side corner of the door; a second top fixing pin being protruded from the top surface of the door to be adjacent to another side corner of the door; a first bottom fixing pin being protruded from a bottom surface of the door to be adjacent to one side corner of the door; and a second bottom fixing pin being protruded from the bottom surface of the door to be adjacent to another side corner of the door.

Also, a link assembly may be applied as a transmission medium to transmit the rotation of the door handle to each fixing pin. The link assembly may be constructed as a multi-fold link portion having various types of shapes and sizes according to a demanded condition. As an example, the link assembly may include: a first connecting link portion pivotably connected with the rotating latch; a second connecting link portion pivotably connected with the rotating latch; a first rotating link portion rotatably mounted inside of the door, on which the first connecting link portion, the first top fixing pin and the first bottom fixing pin are pivotably connected respectively; and a second rotating link portion rotatably mounted inside of the door opposite to the first rotating link portion, on which the second connecting link portion, the second top fixing pin and the second bottom fixing pin are pivotably connected respectively. Depending upon embodiments, the rotation of the door handle may be directly transmitted to the rotating latch by using various types of members such as a rack, a pinion, and the like, without using the rotating bracket

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a perspective view illustrating a financial ATM using a door lock structure according to an exemplary embodiment of the present invention;

FIG. 2 is a perspective view illustrating a door lock structure according to an exemplary embodiment of the present invention;

FIG. 3 is a plan view illustrating a door lock structure according to an exemplary embodiment of the present invention;

FIG. 4 is a cross-sectional view illustrating a combined state of a pinhole member and a fixing pin in a door lock structure according to an exemplary embodiment of the present invention;

FIG. 5 is a perspective view illustrating a structure of a rotating bracket and a rotating latch in a door lock structure according to an exemplary embodiment of the present invention;

FIG. 6 is a cross-sectional view illustrating a structure of a rotating bracket and a rotating latch in a door lock structure according to an exemplary embodiment of the present invention;

FIG. 7 is a plan view illustrating an operating state of a door lock structure according to an exemplary embodiment of the present invention;

FIG. 8 is a perspective view illustrating a door lock structure according to another exemplary embodiment of the present invention;

FIG. 9 is a plan view illustrating a door lock structure according to another exemplary embodiment of the present invention;

FIG. 10 is a plan view illustrating an operating state of a door lock structure according to another exemplary embodiment of the present invention; and

FIG. 11 is a perspective view illustrating an intrusion state of an unauthorized user attempting to open an object having a door lock structure according to an exemplary embodiment of the present invention.

### DETAILED DESCRIPTION OF EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

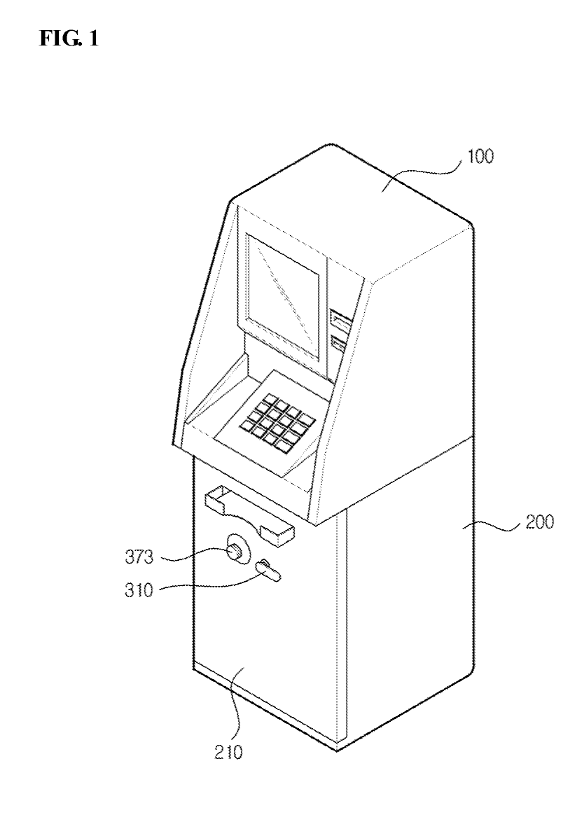

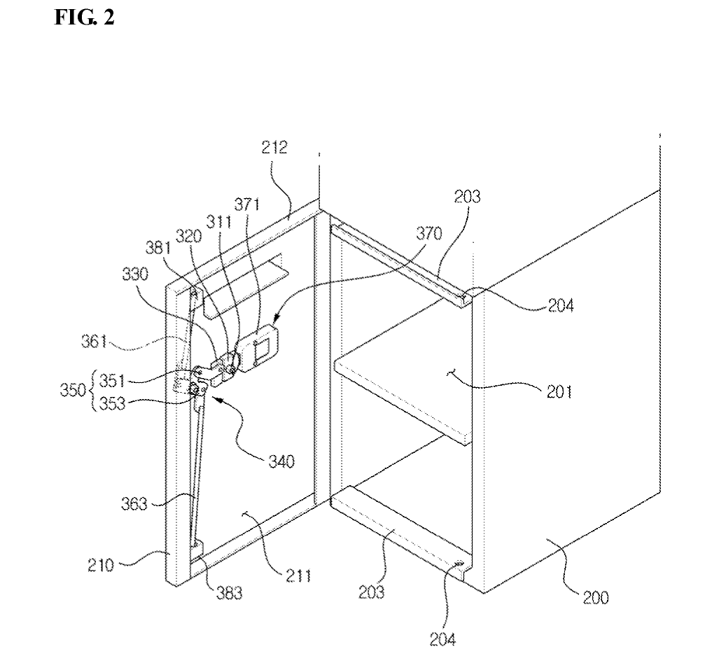

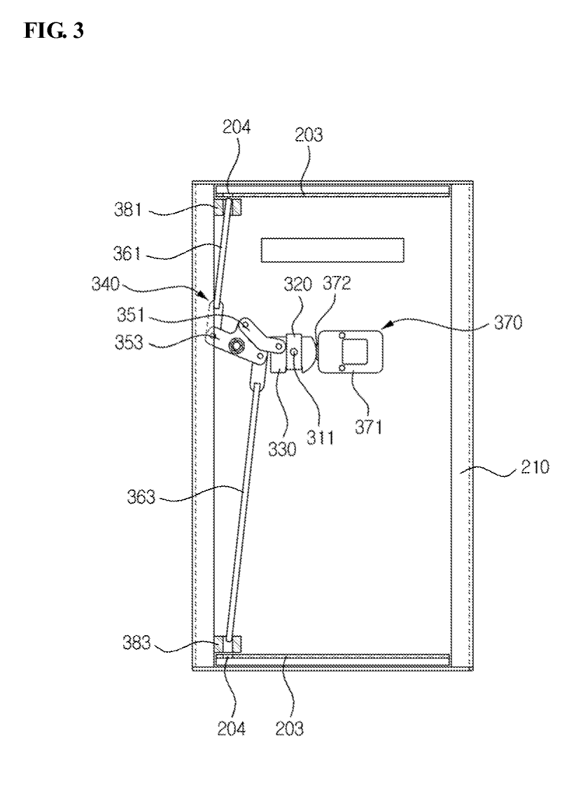

FIG. 1 is a perspective view illustrating a financial Automatic Teller Machine (ATM) using a door lock structure according to an exemplary embodiment of the present invention, FIG. 2 is a perspective view illustrating a door lock structure according to an exemplary embodiment of the present invention, and FIG. 3 is a plan view illustrating a door lock structure according to an exemplary embodiment of the present invention.

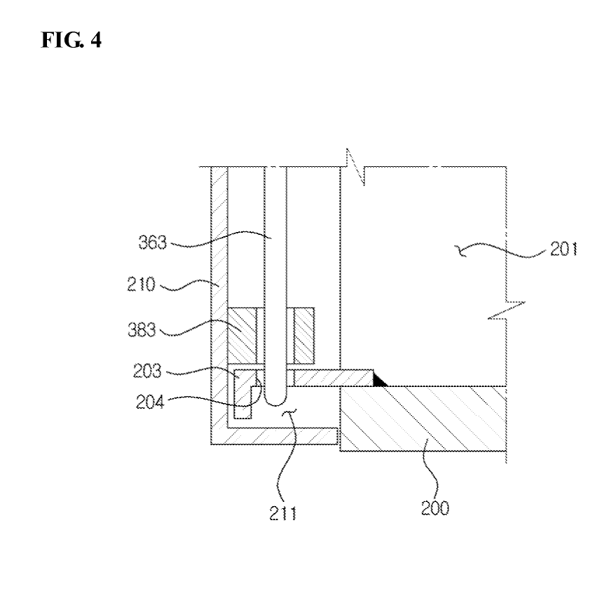

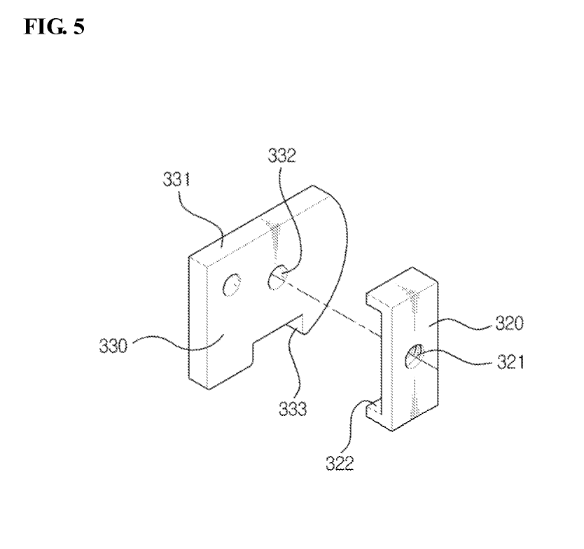

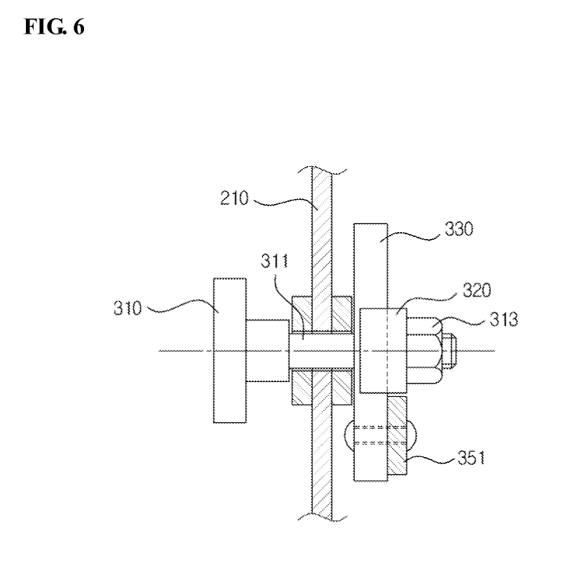

Also, FIG. 4 is a cross-sectional view illustrating a combined state of a pinhole member and a fixing pin in a door lock structure according to an exemplary embodiment of the present invention, FIG. 5 is a perspective view illustrating a structure of a rotating bracket and a rotating latch in a door lock structure according to an exemplary embodiment of the present invention, and FIG. 6 is a cross-sectional view illustrating a structure of a rotating bracket and a rotating latch in a door lock structure according to an exemplary embodiment of the present invention.

Referring to the figures, a door lock structure according to an exemplary embodiment of the present invention includes an object providing a storage space 201; a door 210 being mounted to the object to be capable of opening and closing the storage space 201; a locking pin member 340 being provided inside of the door 210 and including a plurality of fixing pins 361 and 363 which reciprocally moves within a door area restricted by an inside surface of the door 210; and a pinhole member 203 being mounted to the object to selectively combine with the plurality of fixing pins 361 and 363 within the door area when the door 210 is closed.

In this instance, the object indicates a safety apparatus to secure cash, securities, jewelry, confidential documents, and the like, such as a general safe, a financial ATM, and the like. Also, the financial ATM indicates an automated machine which can provide basic financial services, such as a cash withdrawal machine, a cash deposit machine, and the like, without restriction on a time and an occasion and also without a help of a teller.

Hereinafter, an example of a safe 200 of a cash withdrawal machine using a door lock structure according to an exemplary embodiment of the present invention will be described.

As illustrated in FIGS. 1 and 2, the cash withdrawal machine includes a cabinet 100 which forms an external appearance of the cash withdrawal machine, and a plurality of modules which is provided for each functional unit and thereby installed in the cabinet 100. The functional unit modules include a magnetic card reading module, a bankbook arrangement module, a user interface module, a bill withdrawal module, and the like.

Also, the safe 200 having the storage space 201 is provided below the cabinet 100 to keep a cash cassette containing cash. Also, a front opening of the storage space 201 may be opened and closed by the door 210 that is combined with the safe 200 via a hinge. The closed state of the door 210 may be selectively maintained by the locking pin member 340 including the plurality of fixing pins 361 and 363 and the pinhole member 203 which are combined with the plurality of fixing pins 361 and 363.

Hereinafter, an example that a door handle 310 is provided on the external surface of the door 210 to be capable of manipulating a rotation, and the plurality of fixing pins 361 and 363, reciprocally moving within the door area restricted by the inside of the door 210, is combined with the pinhole member 203 according to a rotation manipulation of the door handle 310 via a rotating bracket 320 and a rotating latch 330 will be described. The rotating bracket 320 and the rotating latch 330 are provided inside of the door 210 and interoperate with the door handle 310.

As illustrated in FIGS. 2 through 6, the door handle 310 is provided on the external surface of the door 210 to be capable of manipulating a rotation. A shaft 311 is integrally formed with the door handle 310 and thereby transmits an operating force of the door handle 310. Also, the shaft 311 passes through the door 210 and is protruded from the inside of the door 210.

The rotating bracket 320 is combined with the shaft 311 protruded from the inside of the door 210, and thus may integrally rotate together with the shaft 311. Also, the rotating latch 330 is provided between the door 210 and the rotating bracket 320 to receive a rotary power of the door handle 310 via the rotating bracket 320 and thereby rotate. In this instance, the rotating latch 330 is selectively separable from the rotating bracket 320 along an axial direction of the shaft 311.

Also, the rotating bracket 320 is combined with the rotating latch 330 to cover at least one portion of a circumferential surface of the rotating latch 330, and is formed with at least one of a first binding surface 331 and a second binding surface 322 in a contact surface between the rotating bracket 320 and the rotating latch 330 to thereby restrain the relative rotation. Accordingly, the rotating bracket 320 and the rotating latch 330 may integrally rotate and also be selectively separated from each other along the axial direction of the shaft 311.

Hereinafter, an example that the rotating latch 330 is formed in a non-circular shape having the first binding surface 331 in parallel with both side portions of the circumferential surface of the rotating latch 330, and the rotating bracket 320 is formed in a yoke or “U” shape to cover at least one portion of the circumferential surface of the rotating latch 330 and thereby combine with the rotating latch 330 will be described. In this instance, the second binding surface 322 is formed in both ends of the rotating bracket 320 to make a surface contact with the first binding surface 331 of the rotating latch 330. As described above, the rotating bracket 320 and the rotating latch 330 may be formed to have various types of shapes, such as a D-cut shape, and the like, depending on a required condition.

The present invention is not limited or restricted by the shape of the rotating bracket 320 and the rotating latch 330. However, it may be desirable that the rotating bracket 320 and the rotating latch 330 are formed to be readily separable from each other along the axial direction of the shaft 311.

Also, according to the present exemplary embodiment, a passing hole 332 is formed in a central portion of the rotating latch 330, and the shaft 311 of the door handle 310 passes through the passing hole 332. However, the present invention is not limited thereto and thus the shaft 311 of the door handle 310 may be constructed to not pass through the rotating latch 330.

Also, the shaft 311 and the rotating bracket 320 may be combined with each other by forming a male screw thread in an end of the shaft 311 and providing a combining hole 321 formed with a female screw thread in the rotating bracket 320. Also, the combination state may be fixed by a combining nut 313 and a washer provided on an outside of the rotating bracket 320. Also, depending upon embodiments, the shaft 311 and the rotating bracket 320 may be integrally formed using a combination method, such as a welding, and the like.

As described above, the rotation of the rotating latch 330 may be selectively restrained by a lock assembly 370 mounted inside of the door 210. The door assembly 370 includes a locking body 371 being provided inside of the door 210, and a lock 372 being received in the locking body 371 to be selectively externally withdrawn from the locking body 371. The lock 372, withdrawn from the locking body 371, may make a surface contact with the circumferential surface of the rotating latch 330 and thereby restrain the rotation of the rotating latch 330.

Also, since the locking body 371 mechanically or electrically connects with a locking module 373 provided on the external surface of the door 210, the lock 372 may be selectively withdrawn from the locking body 371 according to an operation of the locking module 373. In this instance, the locking module 373 may include a dial-type locking module, a keypad-type locking module, and the like, which are generally used for the safe 200, to enable only a particular user to utilize the safe 200.

Also, depending upon embodiments, a locking groove 333 may be formed in the circumferential surface of the rotating latch 330 to receive at least one portion of the lock 372 and thereby stably maintain a restrained state of the rotating latch 330 by the lock 372. Also, instead of the locking groove 333, a protrusion may be formed to hook the lock 372.

According to the present exemplary embodiment, the lock 372 directly makes a surface contact with the rotating latch 330 and thereby restrains the rotation of the rotating latch 330. However, the present invention is not limited thereto. Specifically, depending upon embodiments, the lock 372 may restrain the rotating bracket 320, which is combined with the rotating latch 330 to rotate together with the rotating latch 330, and thereby may restrain the rotation of the rotating latch 330 without directly restraining the rotation of the rotating latch 330.

The locking pin member 340 is provided inside of the door 210 to be interoperable with the rotating latch 330, so that the door 210 may be selectively retrained by the safe 200 according to the rotation manipulation of the door handle 310. The locking pin member 340 connects with the rotating latch 330 and interoperates with the rotating latch 330. Also, the locking pin member 340 includes the plurality of fixing pins 361 and 363 which reciprocally moves upwards and downwards according to the rotation manipulation of the door handle 310. In this instance, the plurality of fixing pins 361 and 363 is constructed to reciprocally move within the door area restricted by the inside surface of the door 210, that is, within an area not externally protruded from the door 210.

The pinhole member 203, which is provided within the door area to selectively restrain a free end of the fixing pin 361 or 363, is provided in a front end of the safe 200. In this instance, a pinhole 204 is formed in a front end of the pinhole member 203 to receive the free end of the fixing pin 361 or 363. As described above, the pinhole member 203 may be mounted to the safe 200 using a general combination method, for example, welding, and the like. In the present exemplary embodiment, although the pinhole member 203 is formed in an “L” shape, the shape of the pinhole member 203 may be variously formed according to a required condition and the shape of the door 210.

Also, a receiving space 210, surrounded by border walls 212, is provided inside of the door 210, and the pinhole member 203 is received in the receiving space 211. According to the present exemplary embodiment, the border walls 212 are formed along inside borders of the door 210 so that the receiving space 211 may be formed inside of the door 210. However, the present invention is not limited thereto and thus the receiving space 211 may be formed inside of the door 210 in a form of a groove.

As described above, the plurality of fixing pins 361 and 363 may be restrained by the pinhole member 203 within the door area restricted by the inside surface of the door 210 without being externally protruded from the door 210. Through the above structure, the plurality of fixing pins 361 and 363 may be restrained by the safe 200, without being exposed in the gap between the safe 200 and the door 210.

Also, the pinhole member 203 is formed to have a length corresponding to a width of the storage space 201. When a forceful shock is applied to the gap between the safe 200 and the door 210 from the outside, the above structure may prevent the pinhole member 203 from being readily damaged due to the forceful shock and thus it is possible to delay the time to open the safe 200.

Also, the locking pin member 340 includes a link assembly 350 to be rotatably provided between the rotating latch 330 and the fixing pins 361 and 363. Accordingly, the rotation of the door handle 310 may be transmitted to the fixing pins 361 and 363 via the link assembly 350.

The link assembly 350 may include a connecting link portion 351 and a rotating link portion 353. The connecting link portion 351 is formed in an “L” shape and one end of the connecting link portion 351 pivotably connects with the rotating latch 330. Also, the rotating link portion 353 is formed in a “T” shape and rotatably provided inside of the door 210. In this instance, another end of the connecting link portion 351 pivotably connects with the rotating link portion 353 in a central portion thereof. Also, the connecting link portion 353 is provided between the plurality of fixing pins 361 and 363 which face each other. In this instance, the connecting link portion 353 pivotably connects with one end of each of the plurality of fixing pins 361 and 363.

As described above, each of the fixing pins 361 and 363 connects with the rotating latch 330 via the link assembly 350 and thereby may reciprocally move upwards and downwards, in interoperation with the connecting link portion 351 and the rotating link portion 353, according to the rotation manipulation of the door handle 310. A free end of each of the fixing pins 361 and 363 is selectively received in the pinhole 204 of the pinhole member 203 and thus the locked state of the door 210 may be maintained.

The link assembly 350 and each of the fixing pins 361 and 363 may rotatably connect with each other via a pin or a hinge. Also, a plurality of pin guides 381 and 383 is provided inside of the door 210 to receive the free ends of the fixing pins 361 and 363 respectively and to guide the free ends of the fixing pins 381 and 383 to stably perform a linear motion.

According to the present exemplary embodiment, the link assembly 350 includes the connecting link portion 351 and the rotating link portion 353 to transmit the rotary motion of the rotating latch 330 to each of the fixing pins 361 and 363, that is, the link assembly 350 is constructed using a two-fold link method. However, depending upon embodiments, the link assembly 350 may be constructed using a three-fold link method, a four-fold link method, and the like. In this instance, the present invention is not limited or restricted by the number of link portions. Also, the shape and size of each link portion constituting the link assembly 350 may be appropriately modified according to a motional characteristic.

According to the present exemplary embodiment, the rotation of the door handle 310 is transmitted to each of the fixing pins 361 and 363 via the link assembly 350. However, depending upon embodiments, the rotation of the rotating latch 330 may be transmitted to each of the fixing pins 361 and 363 using various types of members, such as a rack, a pinion, and the like, instead of the link assembly 350.

According to the present exemplary embodiment, each of the fixing pins 361 and 363 is constructed to reciprocally move upwards and downwards and thereby be restrained by the safe 200. However, depending upon embodiments, each of the fixing pins 361 and 363 may be constructed to reciprocally move along the width direction of the door 210 and thereby be restrained by the safe 200.

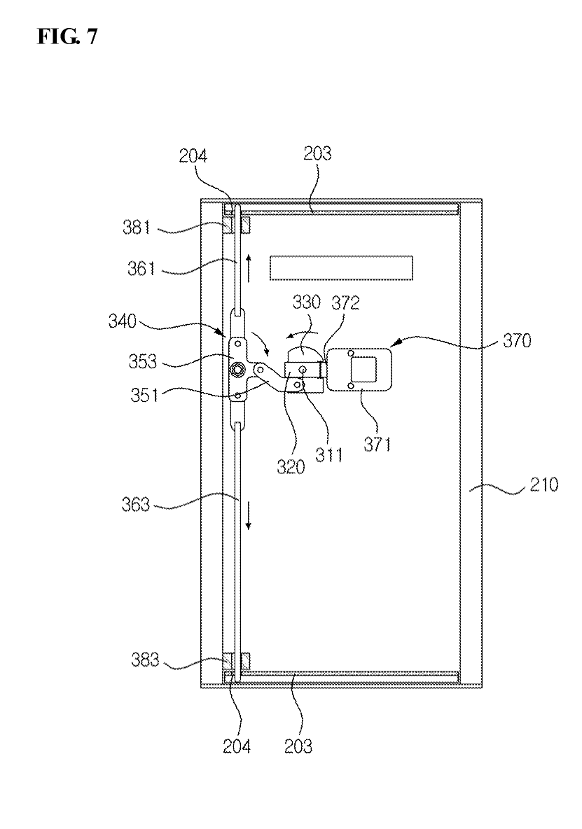

FIG. 7 is a plan view illustrating an operating state of a door lock structure according to an exemplary embodiment of the present invention. Hereinafter, the operating state of the door lock structure according to the present invention will be described with reference to FIG. 7.

When the door 210 is locked, the pinhole member 203, provided in the front end of the safe 200, is positioned inside of the door 210 within the door area via the receiving space 211 of the door 210.

When rotating the door handle 310 counter-clockwise based on the inside of the door 210 to restrain the locked state of the door 210, the shaft 311 is rotated counter-clockwise together with the door handle 310 and the rotating bracket 320 and the rotating latch 330 are also rotated counter-clockwise.

As the rotating latch 330 is rotated counter-clockwise, the connecting link portion 351 and the rotating link portion 353, connected thereto, respectively interoperate with the rotating latch 330, which results in the fixing pins 361 and 363 moving upwards and downwards so that the free end of each of the fixing pins 361 and 363 may be received in the pinhole 204 of the pinhole member 203 and thereby the door 210 may be restrained to be maintained in a closed state. Also, the counter-clockwise rotated state of the rotating latch 330 may be selectively restrained by the lock 372 of the lock assembly 370.

As described above, according to the present exemplary embodiment, the fixing pins 361 and 363 may be restrained by the safe 200 within the door area without being exposed in the gap between the safe 200 and the door 210. Also, although the forceful shock is applied to the gap between the safe 200 and the door 210 from the outside, the fixing pins 361 and 363 may be protected and thus the locked state of the door 210 may be maintained by the fixing pins 361 and 363.

Also, according to the present exemplary embodiment, the shaft 311 of the door handle 310 may not directly connect with the rotating latch 330. Specifically, the shaft 311 may indirectly connect with the rotating latch 330 via the rotating bracket 320 and be separable from the rotating latch 330. Accordingly, although the shaft 311 of the door handle 310 and the rotating bracket 320, integrally formed with the shaft 311, are damaged due to the forceful shock from the outside, the rotating latch 330 and the locking pin member 340 connected thereto may barely be damaged and thus maintain the locked state of the door 210.

In this instance, a general method of opening an object, such as a safe, may include a method of applying a forceful shock to a fixing pin exposed between the safe and a door using a tool, such as a saw, a chisel, and the like, and thereby destroying the fixing pin.

However, according to the present exemplary embodiment, the fixing pins 361 and 363 may be restrained by the safe 200 within the door area without being exposed in the gap between the safe 200 and the door 210 and thus it is possible to delay an intrusion using a saw and the like. Since the fixing pins 361 and 363 are not exposed in the gap between the safe 200 and the door 210, an unauthorized user may not directly apply a forceful shock to and damage the fixing pins 361 and 363. Accordingly, the unauthorized user needs to carry out another operation to disassemble the pinhole member 203. Specifically, it may take some time to open the safe 200 and thus the unauthorized user may not open the safe 200 within a comparatively shorter time.

Also, another method of opening an object, such as a safe, may include a method of applying a forceful shock from an outside, using a drill, a chisel, and the like, and thereby damaging a comparatively fragile door handle and a locking pin member connected thereto.

However, according to the present invention, the shaft 311 of the door handle 310 indirectly connects with the rotating latch 330 via the rotating bracket 320, instead of directly connecting with the rotating latch 330. Accordingly, it is possible to delay the intrusion using the drill, the chisel, and the like. Specifically, although the door handle 310 and the rotating bracket 320 may be damaged due to the forceful shock from the outside, the rotating bracket 320 may be separated from the rotating latch 330. Accordingly, the unauthorized user needs to carry out another operation to disassemble the rotating latch 330. Specifically, it may take some time to open the safe 200 and thus the unauthorized user may not open the safe 200 within a comparatively shorter time.

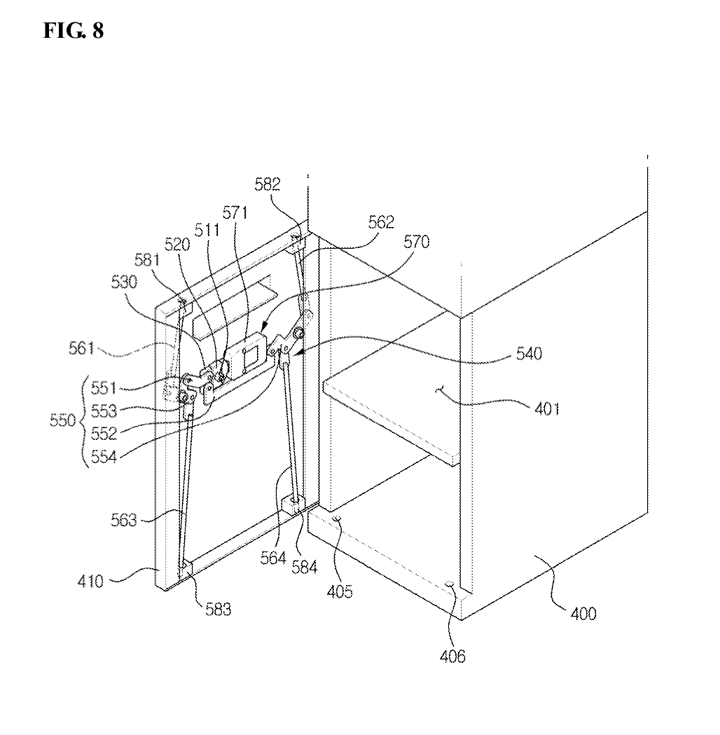

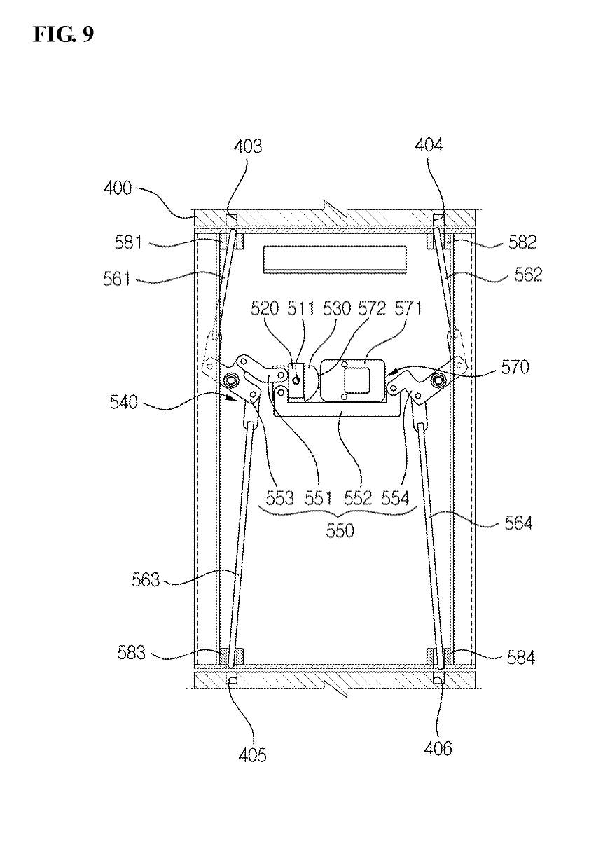

FIG. 8 is a perspective view illustrating a door lock structure according to another exemplary embodiment of the present invention, and FIG. 9 is a plan view illustrating a door lock structure according to another exemplary embodiment of the present invention.

Referring to FIG. 8, in a cash withdrawal machine, a safe 400 having a storage space 401 is provided below a cabinet to keep a cash cassette containing cash. Also, a front opening of the storage space 401 may be opened and closed by a door 410 that is combined with the safe 400 via a hinge. The closed state of the door 410 may be selectively restrained by a door locking apparatus.

As illustrated in FIGS. 8 and 9, a door handle 510 is provided on the external surface of the door 510 to be capable of manipulating a rotation. A shaft 511 is integrally formed with the door handle 510 and thereby transmits an operating force of the door handle 510. Also, the shaft 511 passes through the door 410 and is protruded from the inside of the door 410.

A rotating bracket 520 is combined with the shaft 511 protruded from the inside of the door 410 and thus may integrally rotate together with the shaft 511. Also, a rotating latch 530 is provided between the door 410 and the rotating bracket 520 to rotate together with the rotating bracket 520. In this instance, the rotating latch 530 is selectively separable from the rotating bracket 520 along an axial direction of the shaft 511.

Also, the rotating bracket 520 is combined with the rotating latch 530 to cover at least one portion of a circumferential surface of the rotating latch 530, and is formed with at least one of a first binding surface and a second binding surface (refer to the first binding surface 322 and the second binding surface 331 of FIG. 5) in a contact surface between the rotating bracket 520 and the rotating latch 530 to thereby restrain the relative rotation. Accordingly, the rotating bracket 520 and the rotating latch 530 may integrally rotate and also be selectively separated from each other along the axial direction of the shaft 511.

Hereinafter, an example that the rotating latch 530 is formed in a non-circular shape having the first binding surface in parallel with both side portions of the circumferential surface of the rotating latch 530, and the rotating bracket 520 is formed in a yoke or “U” shape to cover at least one portion of the circumferential surface of the rotating latch 530 and thereby combine with the rotating latch 530 will be described.

In this instance, the second binding surface is formed in both ends of the rotating bracket 520 to make a surface contact with the first binding surface of the rotating latch 530. As described above, the rotating bracket 520 and the rotating latch 530 may be formed to have various types of shapes, such as a D-cut shape, and the like, according to a required condition.

The present invention is not limited or restricted by the shape of rotating bracket 520 and the rotating latch 530. However, it may be desirable that the rotating bracket 520 and the rotating latch 530 are formed to be readily separable from each other along the axial direction of the shaft 511.

Also, according to the present exemplary embodiment, a passing hole (refer to the passing hole 322 of FIG. 5) is formed in a central portion of the rotating latch 530, and the shaft 511 of the door handle 510 passes through the passing hole. However, the present invention is not limited thereto and thus the shaft 511 of the door handle 510 may be constructed to not pass through the rotating latch 530.

Also, the shaft 511 and the rotating bracket 520 may be combined with each other by forming a male screw thread in an end of the shaft 511 and providing a combining hole (refer to the combining hole 321 of FIG. 5) formed with a female screw thread in the rotating bracket 520. Also, the combination state may be fixed by a combining nut 513 and a washer provided on an outside of the rotating bracket 520. Also, depending upon embodiments, the shaft 511 and the rotating bracket 520 may be integrally formed using a combination method, such as a welding, and the like.

As described above, the rotation of the rotating latch 530 may be selectively restrained by a lock assembly 570 mounted inside of the door 410. The door assembly 570 includes a body 571 being provided inside of the door 410, and a lock 572 being received in the body 571 to be selectively externally withdrawn from the body 571. The lock 572, withdrawn from the body 571, may make a surface contact with the circumferential surface of the rotating latch 530 and thereby restrain the rotation of the rotating latch 530.

Also, since the body 571 mechanically or electrically connects with a locking module 573 provided on the external surface of the door 410, the lock 572 may be selectively withdrawn from the body 571 according to an operation of the locking module 573. In this instance, the locking module 573 may include a dial-type locking module, a keypad-type locking module, and the like, which are generally used for the safe 200, to enable only a particular user to utilize the safe 200.

Also, depending upon embodiments, a locking groove 533 may be formed in the circumferential surface of the rotating latch 530 to receive at least one portion of the lock 572 and thereby stably maintain a restrained state of the rotating latch 530 by the lock 572. Also, instead of the locking groove 533, a protrusion may be formed to hook the lock 572.

According to the present exemplary embodiment, the lock 572 directly makes a surface contact with the rotating latch 530 and thereby restrains the rotation of the rotating latch 530. However, the present invention is not limited thereto. Specifically, depending upon embodiments, the lock 572 may restrain the rotating bracket 520, which is combined with the rotating latch 530 to rotate together with the rotating latch 530, and thereby may restrain the rotation of the rotating latch 530 without directly restraining the rotation of the rotating latch 530.

The locking pin member 540 is provided inside of the door 410 to be interoperable with the rotating latch 530, so that the door 410 may be selectively restrained by the safe 400 according to the rotation manipulation of the door handle 510. The locking pin member 540 connects with the rotating latch 530 and interoperates with the rotating latch 530. Also, the locking pin member 540 may include at least four fixing pins 561, 562, 563, and 564 which are externally protruded from the door 410 to be adjacent to corners of the door 410 and be selectively restrained by the safe 400 according to the rotation manipulation of the door handle 510. In this instance, a plurality of combining grooves 403, 404, 405, and 406 are formed to receive free ends of the fixing pins 561 through 564 respectively.

Hereinafter, an example that the locking pin member 540 includes a first top fixing pin 561 and a second top fixing pin 562, which are protruded from the top surface of the door 410 to be adjacent to top corners of the door 410, and a first bottom fixing pin 563 and a second bottom fixing pin 564, which are protruded from the bottom surface of the door 410 to be adjacent to bottom corners of the door 410 will be described.

Specifically, the first top fixing pin 561 is protruded from the top surface of the door 410 to be adjacent to a left corner of the door 410, the second top fixing pin 562 is protruded from the top surface of the door 410 to be adjacent to a right corner of the door 410, the first bottom fixing pin 563 is protruded from the bottom surface of the door 410 to be adjacent to a left corner of the door 410, and the second bottom fixing pin 564 is protruded from the bottom surface of the door 410 to be adjacent to a right corner of the door 410.

Also, the locking pin member 540 includes the link assembly 550 which is rotatably connected between the rotating latch 530 and each of the fixing pins 561 through 564 and thus may transmit the rotation of the door handle 510 to each of the fixing pins 561 through 564 via the link assembly 550.

The link assembly 550 may include a first connecting link portion 551, a second connecting link portion 552, a first rotating link portion 553, and a second rotating link portion 554.

The first connecting link portion 551 is formed in an “L” shape and one end of the first connecting link portion 551 pivotably connects with the rotating latch 530. Also, the second connecting link portion 552 is formed in a yoke or “U” shape and one end of the second connecting link portion 552 pivotably connects with the rotating latch 530.

The first rotating link portion 553 is formed in a “T” shape and rotatably provided inside of the door 410. In this instance, the other end of the first connecting link portion 551 rotatably connects with the first rotating link portion 553 in a central portion thereof. Also, the first rotating link portion 553 is provided between the first top fixing pin 561 and the first bottom fixing pin 563 which face each other. In this instance, the first connecting link portion 553 rotatably connects with one end of each of the first top fixing pin 561 and the first bottom fixing pin 563.

Also, the second rotating link portion 554 is formed in an “L” shape and rotatably provided inside of the door 410 in a location of facing the first rotating link portion 551. Also, the other end of the second connecting link portion 552 rotatably connects with the second rotating link portion 554 in a lower portion thereof. Also, the second rotating link portion 554 is provided between the second top fixing pin 562 and the second bottom fixing pin 564 which face each other. In this instance, the second rotating link portion 554 rotatably connects with one end of each of the second top fixing pin 562 and the second bottom fixing pin 564.

As described above, each of the first and the second top fixing pins 561 and 562, and the first and the second bottom fixing pins 563 and 564 connects with the rotating latch 530 via the link assembly 550 and thereby interoperates with each of the first and second connecting link portions 551 and 552 and the first and second rotating link portions 553 and 554 according to the rotation manipulation of the door handle 510. In this instance, the first and the second top fixing pins 561 and 562, and the first and the second bottom fixing pins 563 and 564 may be selectively protruded from the top surface and the bottom surface of the door 410 respectively, and free ends of the protruded first and the second top fixing pins 561 and 562, and the first and the second bottom fixing pins 563 and 564 are received in the combining grooves 403 through 406 formed in the safe 400 and thus the closed state of the safe 410 may be maintained.

The link assembly 550 and each of the first and the second top fixing pins 561 and 562, and the first and the second bottom fixing pins 563 and 564 may rotatably connect with each other via a pin or a hinge. Also, a plurality of pin guides 581, 582, 583, and 584 is provided inside of the door 410 to receive the free ends of the first and the second top fixing pins 561 and 562, and the first and the second bottom fixing pins 563 and 564 respectively and to guide the free ends of the first and the second top fixing pins 561 and 562, and the first and the second bottom fixing pins 563 and 564 to stably perform a linear motion.

According to the present exemplary embodiment, the link assembly 550 includes a pair of the first connecting link portion 551 and the first rotating link portion 553, and the other pair of the second connecting link portion 552 and the second rotating link portion 554, that is, the link assembly 550 is constructed using a two-fold link method. However, depending upon embodiments, the link assembly 550 may be constructed using a three-fold link method, a four-fold link method, and the like. In this instance, the present invention is not limited or restricted by the number of link portions. Also, the shape and size of each link portion constituting the link assembly 550 may be appropriately modified according to a motional characteristic.

According to the present exemplary embodiment, the rotation of the door handle 510 is transmitted to each of the first and the second top fixing pins 561 and 562, and the first and the second bottom fixing pins 563 and 564 via the link assembly 550. However, depending upon embodiments, the rotation of the rotating latch 530 may be transmitted to each of the first and the second top fixing pins 561 and 562, and the first and the second bottom fixing pins 563 and 564 using various types of members, such as a rack, a pinion, and the like, instead of the link assembly 550.

According to the present exemplary embodiment, each of the first and the second top fixing pins 561 and 562, and the first and the second bottom fixing pins 563 and 564 is constructed to be externally protruded from the top surface and the bottom surface of the door 410 along a height direction of the door 410 and thereby be restrained by the safe 400. However, depending upon embodiments, each of the first and the second top fixing pins 561 and 562, and the first and the second bottom fixing pins 563 and 564 may be constructed to be externally protruded from a side surface of the door 410 along the width direction of the door 410 and thereby be restrained by the safe 400. Also, according to the present exemplary embodiment, the first and the second top fixing pins 561 and 562, and the first and the second bottom fixing pins 563 and 564 are constructed to be protruded in areas adjacent to corners of the door 410 respectively. However, depending upon embodiments, a plurality of fixing pins may be constructed to be protruded in an area adjacent to each of the corners of the door 410. In this instance, the plurality of protruded fixing pins may be spaced apart from the corresponding corner of the door 410 at certain intervals.

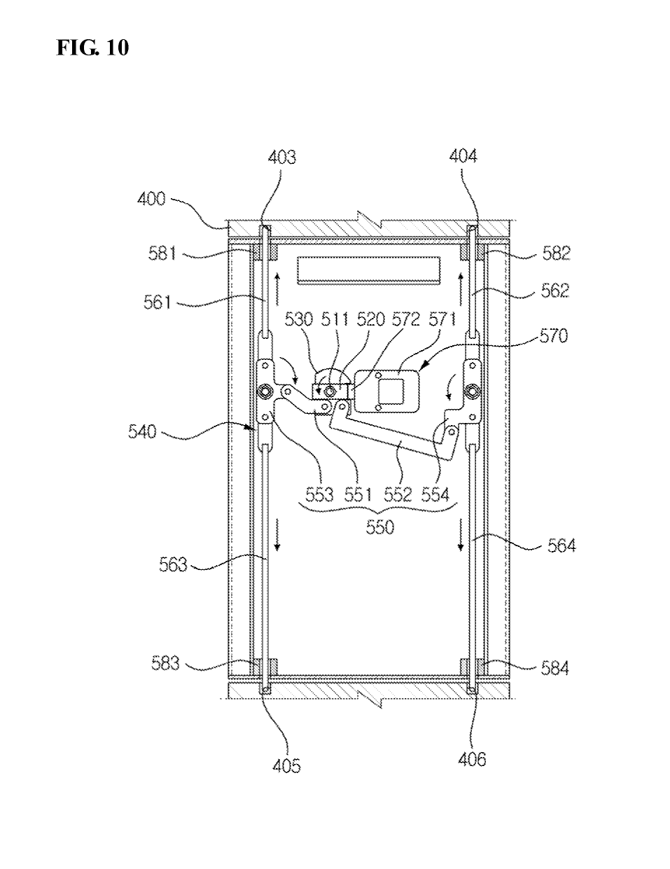

FIG. 10 is a plan view illustrating an operating state of a door lock structure according to another exemplary embodiment of the present invention. Hereinafter, the operating state of the door lock structure will be described with reference to FIG. 10.

When rotating the door handle 510 counter-clockwise based on the inside of the door 410 to restrain the closed state of the door 410, the shaft 511 is rotated counter-clockwise together with the door handle 510 and the rotating bracket 520 and the rotating latch 530 are also rotated counter-clockwise.

As the rotating latch 530 is rotated counter-clockwise, the first and the second connecting link portions 551 and 552 and the first and the second rotating link portion 553 and 554, connected to the rotating latch 530, respectively interoperate with the rotating latch 530, which results in the first and the second top fixing pins 561 and 562, and the first and the second bottom fixing pins 563 and 564 moving upwards and downwards so that the free ends of the first and the second top fixing pins 561 and 562, and the first and the second bottom fixing pins 563 and 564 may be protruded from the top surface and the bottom surface of the door 410 respectively and thereby be received in the combining grooves 403 through 406 formed in the safe 400 and the door 410 may be restrained to be maintained in a closed state. Also, the counter-clockwise rotated state of the rotating latch 530 may be selectively restrained by the lock 572 of the lock assembly 570.

As described above, according to the present exemplary embodiment, a portion corresponding to each corner of the door 410 may be restrained by the safe 400 using a method of fixing four points. Accordingly, although a hinge 411, rotatably connecting with the safe 400 and the door 410, is damaged due to a forceful shock from an outside, the locked state of the door 410 may be maintained by the first and the second top fixing pins 561 and 562, and the first and the second bottom fixing pins 563 and 564.

Also, according to the present exemplary embodiment, the shaft 511 of the door handle 510 may not directly connect with the rotating latch 530. Specifically, the shaft 511 may indirectly connect with the rotating latch 530 via the rotating bracket 520 and be separable from the rotating latch 530. Accordingly, although the shaft 511 of the door handle 510 and the rotating bracket 520, integrally formed with the shaft 511, are damaged due to the forceful shock from the outside, the rotating latch 530 and the locking pin member 540 connected thereto may barely be damaged and thus maintain the locked state of the door 410.

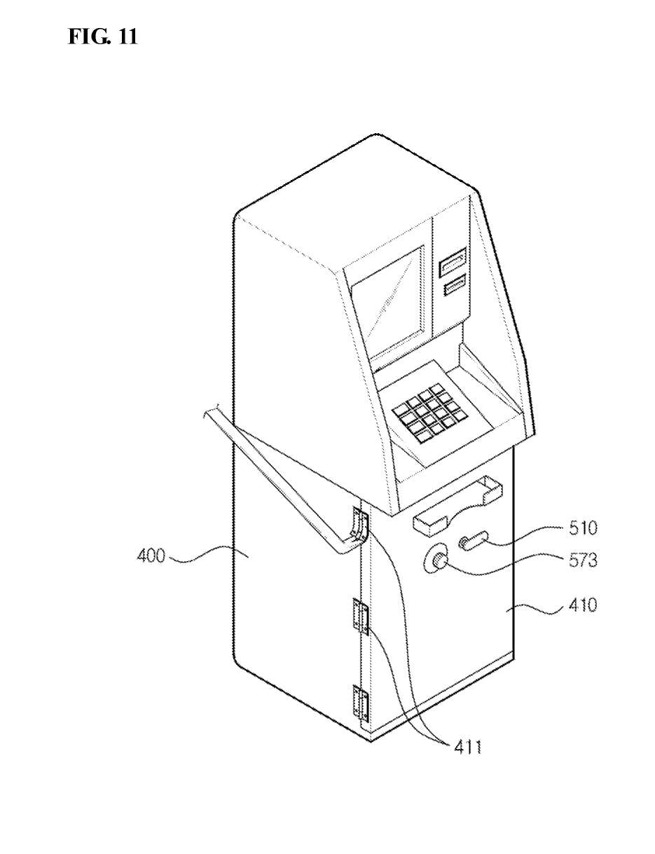

FIG. 11 is a perspective view illustrating an intrusion state of an unauthorized user attempting to open an object having a door lock structure according to an exemplary embodiment of the present invention.

As illustrated in FIG. 11, a method of opening an object, such as a safe, may utilize an instrument such as a claw hammer, and the like. Specifically, a method of dissembling a hinge which connects the safe and a door, with a forceful shock from an outside using the claw hammer, and the like, and then pulling the door towards an opposite direction to the opening and closing direction of the door and thereby destroying a locking pin member, which restrains the door, may be utilized.

However, according to the present exemplary embodiment, when a portion corresponding to each corner of the door 410 is restrained by the safe 400 using a method of fixing four points, it is possible to delay an intrusion using a claw hammer and the like. Although the hinge 411, connecting the safe 400 and the door 410, may be damaged due to the instrument such as the claw hammer and the like, the first and the second top fixing pins 561 and 562, and the first and the second bottom fixing pins 563 and 564 may maintain the locked state of the door 410 and in this state, the door 410 may not be readily pulled back. In this instance, each of the first and the second top fixing pins 561 and 562, and the first and the second bottom fixing pins 563 and 564 restrains the portion corresponding to each corner of the door 410. Accordingly, the unauthorized user needs to carry out another operation to disassemble the first and the second top fixing pins 561 and 562, and the first and the second bottom fixing pins 563 and 564. Specifically, it may take some time to open the safe 400 and thus the unauthorized user may not open the safe 400 within a comparatively shorter time.

Also, another method of opening an object, such as a safe, may include a method of applying a forceful shock from an outside, using a drill, a chisel, and the like, and thereby damaging a comparatively fragile door handle and a locking pin member connected thereto.

However, according to the present invention, the shaft 511 of the door handle 510 indirectly connects with the rotating latch 530 via the rotating bracket 520, instead of directly connecting with the rotating latch 530. Accordingly, it is possible to delay the intrusion using the drill, the chisel, and the like. Specifically, although the door handle 510 and the rotating bracket 520 may be damaged due to the forceful shock from the outside, the rotating bracket 520 may be separated from the rotating latch 530. Accordingly, the unauthorized user needs to carry out another operation to disassemble the rotating latch 530. Specifically, it may take some time to open the safe 400 and thus the unauthorized user may not open the safe 400 within a comparatively shorter time.

As described above, according to the present invention, it is possible to safely secure an object needing a protection, such as a safe and a financial ATM.

Also, according to the present invention, even when a forceful shock is applied to a gap between an object and a door from an outside, it is possible to protect a fixing pin and thus an unauthorized user may not readily open the object within a short time.

Also, according to the present invention, even when a door handle and a shaft of the door handle are damaged due to a forceful shock from an outside, a rotating bracket and a rotating latch may be separated from each other. Accordingly, a locked state of a door may be maintained and thus an unauthorized user may not quickly open an object.

Also, according to the present invention, even when a hinge, rotatably connecting a door and an object, is damaged due to a forceful shock from an outside, each fixing pin may maintain a locked state of a door and thus an authorized user may not quickly open an object.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A door lock structure comprising:
an object providing a storage space;
a door being mounted to the object to be capable of opening and closing the storage space;
a locking pin member being provided inside of the door and comprising a fixing pin which reciprocally moves within a door area restricted by an inside surface of the door; and
a pinhole member being mounted to the object to selectively combine with the fixing pin within the door area when the door is closed.

2. The door lock structure of claim 1, wherein a receiving space, surrounded by border walls, is provided inside of the door, and the pinhole member is received in the receiving space.

3. The door lock structure of claim 1, wherein the fixing pin moves upwards and downwards, and the pinhole member is formed to have a length corresponding to a width of the storage space.

4. The door lock structure of claim 1, wherein the pinhole is formed in the pinhole member to receive a free end of the fixing pin.

5. A door lock structure comprising:
an object providing a storage space;
a door being mounted to the object to be capable of opening and closing the storage space;
a door handle being provided on a external surface of the door;
a rotating bracket being mounted inside of the door to combine with a shaft of the door handle and thereby rotate together with the shaft;
a rotating latch being provided between the door and the rotating bracket and detachably coupled with the rotating bracket to rotate together with the rotating bracket;
a lock assembly being provided inside of the door to selectively restrain a rotation of the rotating latch;
a locking pin member being provided inside of the door to interoperate with the rotating latch, and comprising a fixing pin which reciprocally moves within a door area restricted by an inside surface of the door in correspondence to a rotation of the door handle; and
a pinhole member being mounted to the object to selectively combine with the fixing pin within the door area when the door is closed.

6. The door lock structure of claim 5, wherein a receiving space, surrounded by border walls, is provided inside of the door, and the pinhole member is received in the receiving space.

7. The door lock structure of claim 5, wherein the fixing pin moves upwards and downwards, and the pinhole member is formed to have a length corresponding to a width of the storage space.

8. The door lock structure of claim 5, wherein the pinhole is formed in the pinhole member to receive a free end of the fixing pin.

9. The door lock structure of claim 8, further comprising:
a pin guide being provided to the door to guide the free end of the fixing pin to perform a linear motion.

10. The door lock structure of claim 5, wherein the locking pin member comprises:
a link assembly connecting the rotating latch and the fixing pin to thereby transmit the rotation of the door handle to the fixing pin.

11. The door lock structure of claim 10, wherein the link assembly comprises:
a connecting link portion rotatably connecting with the rotating latch; and
a rotating link portion connecting with the connecting link portion to be rotatable on the door, and rotatably connecting with the fixing pin.

12. The door lock structure of claim 5, wherein the rotating latch provides a first binding surface, and the rotating bracket provides a second binding surface formed corresponding to the first binding surface to be engaged with the first binding surface.

13. The door lock structure of claim 5, wherein the lock assembly comprises:
a locking body being provided inside of the door; and
a lock being received in the locking body to be selectively externally withdrawn from the locking body.

14. A door lock structure comprising:
an object providing a storage space;
a door being mounted to the object to be capable of opening and closing the storage space;
a door handle being provided on an external surface of the door;
a lock assembly being provided inside of the door to selectively restrain a rotation of the door handle; and
a locking pin member comprising at least four fixing pins which move to be externally protruded from the door in side corners of the door respectively in correspondence to the rotation of the door handle, and combines the door and the object.

15. The door lock structure of claim 14, wherein the locking pin member comprises:
a first top fixing pin being protruded from a top surface of the door in one side corner of the door;
a second top fixing pin being protruded from the top surface of the door in another side corner of the door;
a first bottom fixing pin being protruded from a bottom surface of the door in one side corner of the door; and
a second bottom fixing pin being protruded from the bottom surface of the door in another side corner of the door.

16. The door lock structure of claim 15, comprising:
a rotating bracket being integrally formed with a shaft of the door handle to thereby rotate together with the shaft of the door; and
a rotating latch being provided inside of the door to receive the rotation of the door handle via the rotating bracket and thereby rotate,
wherein each of the four fixing pins connects with the rotating latch to be interoperable with the rotating latch.

17. The door lock structure of claim 16, wherein the locking pin member is rotatably connected between the rotating latch and each of the four fixing pins, and thereby transmits the rotation of the door handle to each of the four fixing pins.

18. The door lock structure of claim 17, wherein the link assembly comprises:
a first connecting link portion pivotably connected with the rotating latch;
a second connecting link portion pivotably connected with the rotating latch;
a first rotating link portion rotatably mounted inside of the door, on which the first connecting link portion, the first top fixing pin and the first bottom fixing pin are pivotably connected respectively; and
a second rotating link portion rotatably mounted inside of the door opposite to the first rotating link portion, on which the second connecting link portion, the second top fixing pin and the second bottom fixing pin are pivotably connected respectively.

19. The door lock structure of claim 16, wherein the rotating latch is provided between the door and the rotating bracket, and the rotating bracket is separable from the rotating latch along the shaft of the door handle.

20. The door lock structure of claim 19, wherein the rotating bracket is combined with the rotating latch to cover at least one portion of a circumferential surface of the rotating latch, and is formed with at least one binding surface in a contact surface between the rotating bracket and the rotating latch to thereby restrain the relative rotation.

21. The door lock structure of claim 14, wherein a pinhole is formed in the object to receive a free end of each of the four fixing pins.
